(19) United States
(12) Patent Application Publication
(10) Pub. No.: US 2014/0279175 A1
(43) Pub. Date: Sep. 18, 2014

(54) Quibl Order Process System

(71) Applicant: James C. Graf, Brookfield, WI (US)

(72) Inventor: James C. Graf, Brookfield, WI (US)

(21) Appl. No.: 14/212,454

(22) Filed: Mar. 14, 2014

Related U.S. Application Data
(60) Provisional application No. 61/789,818, filed on Mar. 15, 2013.

(51) Int. Cl. G06Q 30/06

(52) U.S. Cl. CPC G06Q 30/0611; G06Q 30/0635
USPC 705/26.4

(57) ABSTRACT

There is disclosed a system and method including to provide consumer products and services for sale. The system includes a computer readable database and a computer processor coupled to the computer readable database. The computer readable database is configured to store account data. The account data can be, for example customer needs, types of product preferences or service preferences of the customer, addresses, phone numbers, consumer product specifications, etc. The computer processor is coupled to the computer readable database. The computer processor is configured to receive an order from a customer, input the order into an item catalog, and market the order.

### CROSS-REFERENCE TO RELATED PATENT APPLICATIONS

This patent application claims priority to U.S. Provisional Application No. 61/789,818, filed Mar. 15, 2013, incorporated herein in its entirety, by this reference.

### FIELD OF THE INVENTION

This invention relates to product and service transactions, and more particularly to an agency system to facilitate marketing, sales, and delivery of product and services.

### DESCRIPTION OF THE DRAWINGS

These and other advantages of the present disclosure are best understood with reference to the drawings, in which:

FIG. 1 is a diagram illustrating an exemplary embodiment of a system to provide an agency arrangement between vendors, customers, and agent facilitator for marketing, sale, and delivery of products and services;

FIG. 2 is a flow diagram schematically illustrating an exemplary embodiment of a method of providing an agency facilitation in which a disclosed quibl process markets, manages, tracks, confirms, and organizes fulfillment of one of product and services requests.

FIG. 3 is a flow diagram schematically illustrating an exemplary embodiment of a method of providing an agency facilitation in which a disclosed quibl process markets, manages, tracks, confirms, and organizes fulfillment of one of product and service request.

### SUMMARY OF THE INVENTION

There is disclosed a system configured to provide consumer products and services for sale. The system includes a computer readable database and a computer processor coupled to the computer readable database.

The computer readable database is configured to store account data. The account data can be, for example customer needs, types of product preferences or service preferences of the customer, addresses, phone numbers, consumer product specifications, etc.

The computer processor is coupled to the computer readable database. The computer processor is configured to receive an order from a customer, input the order into an item catalog, and market the order.

The computer processor is further configured to present the order for a price bid to a plurality of vendors and receive the price bid from each of the plurality of vendors.

The computer processor is also configured to organize all price bids from each of the plurality of vendors, present a winning bid from one of the plurality of vendors to the customer, and purchase the order from one of the plurality of vendors for shipping to the customer.

The computer processor can also be configured to aggregate orders, confirm the order with the customer, and confirm the winning bid with the customer. The computer processor is also configured to execute payment from the customer and to execute payment with one of the plurality of vendors. In another embodiment, the system is coupled to an internet protocol facilitating one of a product and service transaction.

There is also disclosed a method of providing consumer products and services for sale. The method includes providing a computer readable database configured to store account data and provide a computer processor coupled to the computer readable database.

The computer processor is configured for receiving an order from a customer and inputting the order into an item catalog. The computer processor is also configured for marketing the order and presenting the order for a price bid to a plurality of vendors and receiving the price bid from each of the plurality of vendors.

The computer processor is also configured for organizing all price bids from the plurality of vendors and presenting a winning bid from one of the plurality of vendors to the customer and purchasing the order from one of the plurality of vendors for shipping to the customer.

There is additionally disclosed a method of providing consumer products and services for sale. The method includes providing a computer readable database configured to store account data and a computer processor.

The computer processor is configured for organizing all price terms from a plurality of vendors and selecting a primary vendor from the plurality of vendors for a time period.

The computer processor is also configured for inputting products and services into an item catalog from the primary vendor and marketing the item catalog by selecting a product or service from the item catalog and purchasing the product or service from the item catalog.

The computer processor is also configured for executing payment from the customer, executing payments from one of the plurality of vendors.

The computer processor can be coupled to an internet protocol facilitating one of a product and service transaction and further configured for updating item catalog for a time period and configured for purchasing the item or service from one of a secondary vendor.

### DETAILED DESCRIPTION OF THE EXEMPLARY EMBODIMENTS

The Quibl process 100 is available for consumer products and services, for example, sports equipment, apparel, accessories, furniture, car equipment, construction equipment, household wares, childcare items, and personal services, and similar or associated items.

With reference to FIG. 1, Quibl 100 maintains a vendor (or bidder) database 102 coupled to a processor 104. The vendor database 102 is comprised of retail vendors obtained from various sources, including Internet resources and non-Internet resources.

Quibl 100 maintains an item catalog 106 coupled to processor 104. The item catalog 106 includes a plurality of items available for purchase. The item catalog may also include personal services available for purchase. The item catalog includes items that are presently being bid upon, as well as items that have already been purchased but which may be purchased again, as well as suggested items that are available for bid.

Quibl 100 maintains a customer (or originator) database 108 coupled to processor 104. The customer database 108 includes, but is not limited to, customer data that is received by the customer database through the Quibl website 110 and/or by a Quibl employee, contractor, or other third-party. The customer database 108 includes, but is not limited to, name, address, phone number, email address, and item request specifications or other information.

The vendor database 102, item catalog 106, and customer database 108 are computer readable databases configured to store account data and are continually open to additions and deletions.

Quibl 100 also maintains a Back Office User Interface 112 (BOUI) which is coupled to processor 104 and which includes both an input 114 and an output 116 (or display). The input 116 includes at least customer information, item information, vendor information, financial information, and retail information. The output 116 can include at least customer information, item information, vendor information, financial information, and retail information.

Customers can access the Quibl process 100 through a variety of ways, including but not limited to, website access, mobile interface application, social media (including, but not limited to Facebook and Twitter), telephone access, for example, a smartphone, facsimile access, face-to-face access, text message access, and electronic mail access.

The Quibl Order Process System 118 (QOPS) includes at least a) a build order process 120, b) a work-in-process (WIP) order management 122, and c) an order fulfillment 124.

The QOPS 118 communicates with the vendor database 102, the item catalog 106, the customer database 108, and the BOUI 112 to operate the build order process 120, WIP order management 122, and order fulfillment 124.

Quibl 100 operates in the following manner:

Referring to FIG. 2, an originator inputs an item request using a Quibl user interface. The Quibl user interface is a portal for allowing a customer 128, vendor 126, or other third party to communicate and interact with Quibl. The item request is transferred to the QOPS where the item request is input into the item catalog.

The item request includes, but is not limited to the item specifications (including but not limited to color, size, length, width, model year, model, and manufacturer) as well as a timeframe. The item request is transferred to a plurality of bidders in the vendor database. The item request can be conveyed to the bidders in a plurality of ways, including but not limited to, electronic mail, telephone call, mobile interface application, social media, or face-to-face contact. The plurality of bidders input a price and timeframe into the QOPS. Quibl receives the bid information from the plurality of bidders and determines the lowest price available within the requested timeframe.

Quibl can also determine other information from the plurality of bidders, including but not limited to, the lowest price within a determined location or other parameters. As part of order fulfillment, Quibl will transfer the lowest price information or lowest price location information to the originator. The originator then completes the order process by agreeing to accept the offered price. Quibl then accepts and processes the payment information and forwards the agreed upon amount to the winning bidder. Payment is received by the relevant bidder, and the requested item is shipped within the requested timeframe to the originator.

Alternatively, a plurality of customers can join other orders or item requests, thereby increasing the quantity of items requested. For example purposes only, an originator may request a pair of size 9 women's Wellington rainboots in green. Quibl will post the item request in the item catalog, accessible, among other places, on the Quibl website interface. A plurality of originators may join the open order for the same item. Accordingly, if two additional customers join the open order, the requested number of size 9 women's Wellington rainboots in green increases from one pair to three pair when the order goes out to the bidders 126 for bidding. The bidder enters a price to sell and can enter a price lower than another bidder. Accordingly, additional savings may be realized though a bulk order.

In other embodiments, the plurality of customers may search the item catalog to determine open orders in which to join.

In other embodiments, a vendor 126 can upload selected retail items into the Quibl item catalog. Those items are then part of the item catalog and available for searching and requesting by other customers 108, 128 utilizing the item catalog 106. The vendor 126 may update the items in the item catalog 106 as needed to provide accurate item information, including, for example, but not limited to price, size, color, and style.

In other embodiments, an order can include more than one of a different item from the item catalog. For example, an open order for a single bid could include a pair of skis and a ski jacket.

In further embodiments and with reference to FIG. 2, a customer 128 originates an order by using the Quibl user interface. Quibl will confirm the order with the customer. Quibl inputs the order into the item catalog. Quibl markets the order including, but not limited to social media (including but not limited to Facebook and Twitter), electronic email, mobile interface application, telephone, facsimile, and other advertising routes. In further embodiments, Quibl can aggregate additional orders of similar or same item or category. Quibl takes the order or a plurality of orders out to bid with the vendors or bidders. Quibl receives any bids from the vendors and organizes all of the bids from the vendors. Quibl presents a winning bid to the customer. The winning bid can include, but is not limited to, the lowest price of all vendors, the lowest price of all vendors in a determined location, or other parameters specified by either or all of the customer, the vendor or Quibl. The customer confirms the winning bid and executes payment with Quibl. Quibl purchases the order items from the vendor and has them shipped to the customer.

In other embodiments, a customer originates an order by using the Quibl user interface. Along with the requested item specifications, the customer can indicate a specified price. The specified price is advance confirmation for Quibl to immediately execute the transaction upon meeting the price specification. Quibl will confirm the order with the customer. Quibl inputs the order into the item catalog. Quibl markets the order including, but not limited to social media (including but not limited to Facebook and Twitter), electronic email, mobile interface application, telephone, facsimile, and other advertising routes. In further embodiments, Quibl can aggregate additional orders of similar or same item or category. Quibl takes the order or a plurality of orders out to bid with the vendors or bidders. Quibl receives any bids from the vendors and organizes all of the bids from the vendors. When a bid meets the customer's specified price (or is lower than the customer's specified price), Quibl will execute payment. Quibl purchases the order items from the vendor and has them shipped to the customer.

In further embodiments and with reference to FIG. 3, a system processor 204, including but not limited to a computer readable database and a computer processor, accesses a vendor database 202 to negotiate or otherwise manage purchase terms regarding a product category or a plurality of product categories for a time frame with a vendor or a plurality of vendors (210). The purchase terms can include, but are not limited to, a percentage discount, a commission, or other pricing agreement. The product category can include, but is not limited to an item or service or a plurality of items or services available for purchase through the vendor. The time frame can be any time period, including, but not limited to a day, a week, a month, a sports season, or other time period. Accordingly, the vendors 202 can bid on individual orders and also on future demand of a bulk order. The vendor 202 provides access to a vendor item catalog to update the item catalog daily or on another of a time period (215).

A customer or member 208 accesses the item catalog 215 to view, search, and request products and services. The customer 208 selects and purchases the item or service from the item catalog (230). The processor 204 then accepts and processes the payment information and forwards the agreed upon amount to the vendor (220). Payment is received by the relevant vendor 202, and the requested item is shipped within the requested time frame to the customer 208.

In still further embodiments, Quibl partners with a plurality of vendors to fulfill future orders within a product category while bidding out forward demand within a product category to realize wholesale pricing for the customers. The selected vendor provides Quibl with access to their product inventory at discounted or wholesale price levels to update the Quibl item catalog. Quibl partners with multiple retailers to adequately represent athletic and sport related apparel, footwear, gear, equipment, and accessories. Quibl then markets the item catalog to customers or members. The customers can include, but are not limited to organizations, schools, and individuals. The customers utilize Quibl to realize preferred pricing on products in the item catalog. The purchasing transactions are between Quibl and the customer. The vendors receive payment from Quibl and fulfill the orders to the customer.

In still further embodiments, as the customer base grows, demand for the Quibl system and method, also referred to as a platform, will grow, thereby attracting more of a plurality of vendors for negotiating price agreements. In some embodiments and utilizing a tiered retailer system, a primary vendor will fulfill orders, and a secondary vendor will fulfill any order that the primary vendor cannot fulfill.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present mechanism has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the mechanism as described herein may be made, none of which depart from the spirit or scope of the present disclosure. The particular embodiments and applications were chosen and described to provide the best illustration of the principles of the mechanism and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A system configured to provide consumer products and services for sale, the system comprising:
a computer readable database configured to store account data; and
a computer processor coupled to the computer readable database, with the computer processor configured to:
receive an order from a customer;
input the order into an item catalog;
market the order;
present the order for price bid to a plurality of vendors;
receive the price bid from each of the plurality of vendors;
organize all price bids from each of the plurality of vendors;
present a winning bid from one of the plurality of vendors to the customer; and
purchase the order from one of the plurality of vendors for shipping to the customer.

2. The system of claim 1, further comprising the computer processor configured to aggregate orders.

3. The system of claim 1, further comprising the computer processor configured to confirm the order with the customer.

4. The system of claim 1, further comprising the computer processor configured to confirm the winning bid with the customer.

5. The system of claim 1, further comprising the computer processor configured to execute payment from the customer.

6. The system of claim 1, further comprising the computer processor configured to execute payment with one of the plurality of vendors.

7. The system of claim 1, further comprising the computer coupled to an internet protocol facilitating one of a product and service transaction.

8. A method of providing consumer products and services for sale, the method comprising:
providing a computer readable database configured to store account data; and
providing a computer processor coupled to the computer readable database, the computer processor being configured to:
receiving an order from a customer;
inputting the order into an item catalog;
marketing the order;
presenting the order for a price bid to a plurality of vendors;
receiving the price bid from each of the plurality of vendors;
organizing all price bids from the plurality of vendors;
presenting a winning bid from one of the plurality of vendors to the customer; and
purchasing the order from the one of plurality of vendors for shipping to the customer.

9. The method of claim 8, further comprising the computer processor aggregating the orders.

10. The method of claim 8, further comprising the computer processor confirming the order with the customer.

11. The method of claim 8, further comprising the computer processor confirming the winning bid with the customer.

12. The method of claim 8, further comprising the computer processor executing payment from the customer.

13. The method of claim 8, further comprising the computer processor executing payment with one of the plurality of vendors.

14. The method of claim 8, further comprising coupling the computer processor to an internet protocol.

15. A method of providing consumer products and services for sale, the method comprising:
providing a computer readable database configured to store account data; and
providing a computer processor coupled to the computer readable database, the computer processor being configured to:
organizing all price terms from a plurality of vendors;
selecting a primary vendor from the plurality of vendors for a time period;
inputting products and services into an item catalog from the primary vendor;
marketing the item catalog;
selecting a product or service from the item catalog; and
purchasing the product or service from the item catalog.

16. The method of claim 15, further comprising, the computer processor executing payment from the customer.

17. The method of claim 15, further comprising, the computer processor executing payment with the one of the plurality of vendors.

18. The method of claim 15, further comprising the computer coupled to an internet protocol facilitating one of a product and service transaction.

19. The method of claim 15, further comprising updating the item catalog for a time period.

20. The method of claim 15, further comprising, purchasing the item or service from one of a secondary vendor.
